(19) United States
(12) Patent Application Publication
(10) Pub. No.: US 2009/0245392 A1
(43) Pub. Date: Oct. 1, 2009

(54) METHOD AND SYSTEM FOR CONCEALING ERRORS

(76) Inventors: Raymond W.K. Leung, Shenzhen (CN); Jun Yao, Shenzhen (CN); Yanzhou Ma, Shenzhen (CN); Yilin Chang, Shenzhen (CN); Junyan Huo, Shenzhen (CN)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/483,454

(22) Filed: Jun. 12, 2009

Related U.S. Application Data
(63) Continuation of application No. PCT/CN2007/000354, filed on Dec. 12, 2007.

(30) Foreign Application Priority Data
Dec. 12, 2006 (CN) 200610167247.8

(51) Int. Cl. H04N 7/26; H04L 27/28; H04L 27/38

(52) U.S. Cl. 375/240.27; 375/260; 375/340; 375/320; 375/E07.126

(57) ABSTRACT

A method for concealing errors includes that the transmitting end splits the received compressed video data into slice structures, allocates the adjacent slice structures to non-adjacent OFDM sub-channels or sub-channel groups, and sends the slice structures to the receiving end; the receiving end conceals the errors on a slice structure according to the slice structure which is chronologically or spatially related to the erroneous slice structure if detecting that any error occurs on the slice structure. The transmitting end includes a slice splitting module and a frequency domain interleaving module; the receiving end includes a domain de-interleaving module, a decompression and error detecting module, and an error concealing module.

This application is a continuation of International Application No. PCT/CN2007/003547, filed on Dec. 12, 2007, which claims the priority of Chinese Patent Application No. 200610167247.8 filed on Dec. 12, 2006, titled “Method and System for Concealing Errors”, the entire contents of all of which are incorporated herein by reference.

### FIELD OF THE DISCLOSURE

The present disclosure relates to the field of video transmission technologies and in particular to a method and system for concealing errors, a transmitting end, and a receiving end.

### BACKGROUND OF THE DISCLOSURE

With the development of communication technologies, video streams can be transmitted over radio channels. As a core technology of mobile communication in the future, Orthogonal Frequency Division Multiplexing (OFDM) will be a primary modulation technique for broadband radio transmission. However, the OFDM channel is characterized by time varying and frequency selection fading, and may generate errors in the transmission process. Video data transmitted over OFDM channels may be vulnerable to errors. Especially in the case of burst errors, video transmission may incur massive packet loss. Consequently, a large number of video blocks are lost at the receiving end, which impairs the video data recovery quality drastically. When errors occur, the receiving end needs to conceal the errors of data in order to recover the original video data as far as possible.

FIG. 1 shows the process of concealing errors of video data transmitted over OFDM channels in the prior art. The process includes the following steps:

Step 101: Video data is received.

Step 102: Channel encoding for video data is performed.

Step 103: Quadrature Amplitude Modulation (QAM) mapping for encoded data is performed.

Step 104: Pilot signals are inserted into the set OFDM sub-channel.

Step 105: Inverse Fast Fourier Transform (IFFT) for the QAM-mapped data and the inserted pilot signals is performed to obtain OFDM symbols.

Step 106: A guard interval is inserted between OFDM symbols to obtain a complete OFDM signal.

Step 107: After receiving the OFDM signal, the receiving end removes the guard interval, performs Fast Fourier Transform (FFT), performs channel feature estimation and correction and channel decoding according to the inserted pilot signal, and obtains the original compressed video data.

Step 108: The receiving end decompresses the compressed video data, and detects errors in the video data. According to the error features such as error position, the receiving end conceals the errors through time domain (e.g., video data whose position is related to the position of the erroneous data in adjacent frame) or space domain (e.g., adjacent video data in the same frame), and recovers the video data.

In the channel decoding process, the transmitting end inserts check information into video data. The receiving end may detect errors of the video data through the check information.

When many errors occur continuously, the errors of several continuous frames usually occur on multiple adjacent OFDM sub-channels concurrently. Namely, the adjacent data in the same frame and the data in the counterpart position of the adjacent frame generate errors concurrently. It is evident that, on this occasion, the errors occur on the same area of the continuous frames, and hence it is impossible to use the space relevance or time relevance to conceal errors of data effectively or recover the original video data correctly, which deteriorates the video output quality.

### SUMMARY

The present disclosure provides a method and system for concealing errors, a transmitting end, and a receiving end to improve the efficiency of concealing errors.

The technical solution under an embodiment of the present disclosure includes as follows:

A method for concealing an error includes:

receiving, by a transmitting end, compressed video data and splitting the compressed video data into slice structures;

allocating an adjacent slice structure to a non-adjacent QFDM sub-channel or sub-channel group and sending the slice structure to a receiving end;

reading, by the receiving end, the slice structure from the OFDM sub-channel or sub-channel group and detecting the slice structure; and

if an error is detected on a slice structure, concealing the error of the slice structure according to the slice structure which is chronologically or spatially related to the erroneous slice structure.

A system for concealing an error includes:

a transmitting end, configured to, after receiving compressed video data input externally, split the compressed video data into slice structures, allocate adjacent slice structures to a non-adjacent OFDM sub-channel or sub-channel group, and send the slice structures to a receiving end; and

the receiving end, configured to read the slice structures on the OFDM sub-channel or sub-channel group from the transmitting end, and, if an error is detected on a slice structure, conceal the error of the slice structure according to the slice structure which is chronologically or spatially related to the erroneous slice structure.

The transmitting end further includes:

a slice splitting module, configured to split compressed video data input externally into slice structures and send the slice structures to the frequency domain interleaving module; and

a frequency domain interleaving module, configured to allocate the received adjacent slice structures of the current video frame to the non-adjacent OFDM sub-channel or sub-channel group and send the slice structures to the receiving end.

The receiving end further includes:

a frequency domain de-interleaving module, configured to read the slice structures on each OFDM sub-channel or sub-channel group from the transmitting end, arrange the slice structures, and send the arranged slice structures to the decompression and error detection module;

a decompression and error detection module, configured to decompress the received slice structure, and if an error is detected on the slice structure, send the slice structure information to the error concealing module; and

an error concealing module, configured to, after receiving the slice structure information from the decompression and error detection module, conceal the error of the slice structure according to the slice structure which is chronologically or spatially related to the erroneous slice structure.

Compared with the related art, the embodiments of the present disclosure use a transmitting end to split the compressed video data into slice structures, and allocate the adjacent slice structures to non-adjacent OFDM sub-channels or sub-channel groups, which slash the probability of errors simultaneously occurring on the adjacent slice structures in the same video frame, improve the error concealment efficiency and video recovery quality greatly.

Further, the embodiments of the present disclosure update the rules of allocating adjacent slice structures to non-adjacent OFDM sub-channels or sub-channel groups, which slash the probability of errors simultaneously occurring on the slice structures in the counterpart position of the adjacent video frame, and further improve the error concealment efficiency and video recovery quality.

### BRIEF DESCRIPTION OF THE DRAWINGS

FIG. 1 shows a process of transmitting video data on an OFDM channel and concealing errors in the related art;

FIG. 2 shows a process of transmitting video data on an OFDM channel and concealing errors in an embodiment of the present disclosure;

FIG. 3 shows a process of transmitting video data on an OFDM channel and concealing errors when the compressed video data is a stream-oriented application according to the first embodiment of the present disclosure;

FIG. 4 shows a process of transmitting video data on an OFDM channel and concealing errors when the compressed video data is a packet-oriented application according to the second embodiment of the present disclosure;

FIGS. 5-1, 5-2 and 5-3 show instances of concealing errors after frequency domain interleaving is performed for the compressed video data in an embodiment of the present disclosure;

FIGS. 6-1, 6-2 and 6-3 show instances of concealing errors after frequency domain interleaving and time domain interleaving are performed for the compressed video data in an embodiment of the present disclosure;

FIG. 7 shows the composition of a system for transmitting compressed video data on an OFDM channel and concealing errors in an embodiment of the present disclosure;

FIG. 8 shows the structure of a transmitting end provided in an embodiment of the present disclosure;

FIG. 9 is the first schematic diagram of the structure of a frequency domain interleaving module of the transmitting end in an embodiment of the present disclosure;

FIG. 10 is the second schematic diagram of the structure of a frequency domain interleaving module of the transmitting end in an embodiment of the present disclosure; and

FIG. 11 shows the structure of a receiving end provided in an embodiment of the present disclosure.

### DETAILED DESCRIPTION

The present disclosure is hereinafter described in detail with reference to embodiments and accompanying drawings.

One embodiment of the present disclosure includes a transmitting end that splits the input compressed video data into slice structures, allocates adjacent slice structures to non-adjacent OFDM sub-channels or sub-channel groups, and sends them to a receiving end. The receiving end rearranges the slice structures on the OFDM sub-channels or sub-channel groups, and detects errors. If an error is detected on a slice structure, the receiving end conceals the error of the slice structure according to the slice structure which is chronologically or spatially related to the erroneous slice structure.

In one embodiment of the present disclosure, the method for allocating adjacent slice structure to non-adjacent OFDM sub-channels or sub-channel groups is called “frequency domain interleaving method”.

Further, in an embodiment of the present disclosure, the rule of allocating the slice structures to OFDM sub-channels or sub-channel groups may be modified at intervals. Namely, different frequency domain interleaving methods may be used at different times. This method is called “time domain interleaving method”.

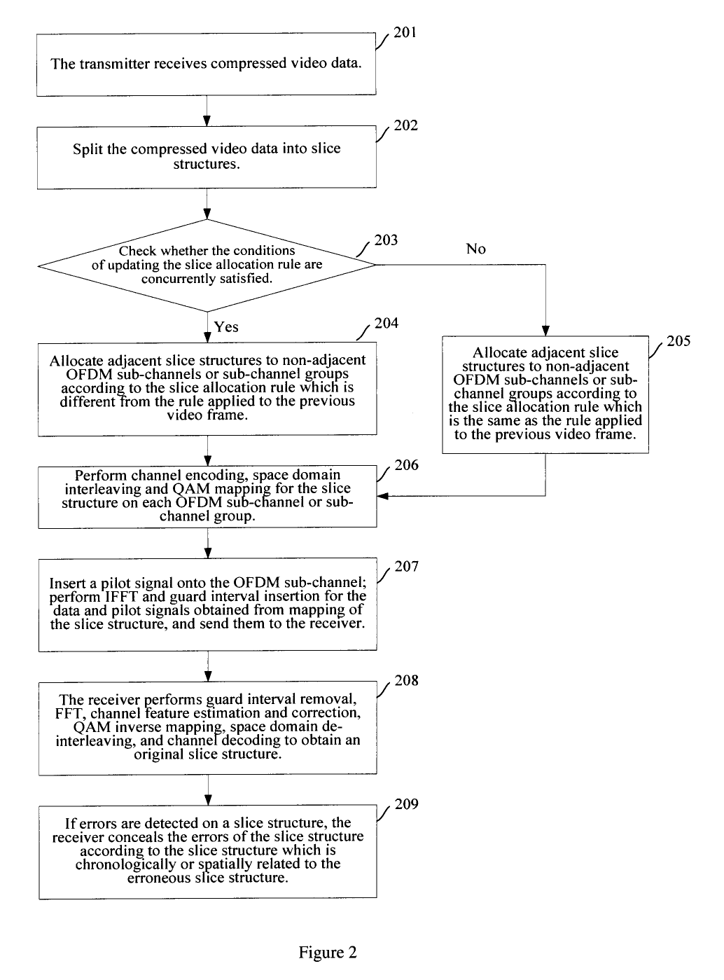

FIG. 2 shows a process of concealing errors during transmission of compressed video data on an OFDM channel in an embodiment of the present disclosure. The process includes the following steps:

Step 201: Compressed video data is received.

Step 202: The received compressed video data is split into slice structures.

The method of splitting a slice structure is defined in the existing video compression standards. In this step, the slice structure of the compressed video data may be split according to the video compression standards.

Step 203: It is determined whether the conditions of updating the slice allocation rule are currently satisfied. If satisfied, the process proceeds to 204; otherwise, step 205 is performed.

Step 204: Adjacent slice structures are allocated to non-adjacent OFDM sub-channels or sub-channel groups according to the slice allocation rule which is preset and different from the rule applied to the previous video frame. The process proceeds to step 206.

Step 205: Adjacent slice structures are allocated to non-adjacent OFDM sub-channels or sub-channel groups according to the slice allocation rule which is the same as the rule applied to the previous video frame.

Generally, the total number of OFDM sub-channels (M) is greater than the total number of slice structures (N). Suppose that K=└M/N┘, namely, K is a result of rounding down the quotient of M divided by N, then K is the quantity of OFDM sub-channels contained in each OFDM sub-channel group, and each OFDM sub-channel group corresponds to a slice structure; if P=M % N and P is not 0, then the control data (such as frequency domain interleaving and time domain interleaving control data) is transmitted on the remaining P OFDM sub-channels. If P=0, the control data together with a slice structure is allocated to an OFDM sub-channel.

Step 206: Channel encoding, space domain interleaving and QAM mapping are performed for the slice structure allocated to each OFDM sub-channel or sub-channel group.

Step 207: A pilot signal is inserted into the OFDM sub-channel; IFFT and guard interval insertion are performed for the data obtained from mapping of QAM and the inserted pilot signal to obtain OFDM signals, and the OFDM signals are sent to the receiving end.

Step 208: After receiving the OFDM signal, the receiving end removes the guard interval, performs Fast Fourier Transform (FFT), performs channel correction and channel decoding according to the inserted pilot signal, and obtains the original slice structure on each OFDM sub-channel or sub-channel group.

Step 209: The receiving end decompresses the compressed video data composed of slice structures, and detects errors; if any error is detected on a slice structure, the receiving end conceals the error of the slice structure according to the successfully received slice structure which is chronologically or spatially related to the erroneous slice structure.

More particularly, the slice structure chronologically related to the erroneous slice structure refers to the slice structure which is located in the reference video frame of the video frame containing the erroneous slice structure, and is related to the position of the erroneous slice structure. The reference video frame may be the frame which is one or two frames ahead of the current video frame. The reference video frame information is sent to the decoder through compressed code streams. The slice structure is composed of macro blocks. Each macro block includes motion vector information which indicates the motion distance of the macro block in the current video frame relative to the reference video frame. Therefore, according to the motion vector information of one macro block, another macro block closest to the foregoing macro block (namely, the one most pertinent to the foregoing macro block) can be searched out in the reference video frame. Therefore, when a macro block in the slice structure incurs errors, the macro block most pertinent to the erroneous macro block may be searched out in the reference video frame according to the motion vector information in the erroneous macro block, and the errors of the erroneous macro block may be concealed according to the pertinent macro block.

The slice structure spatially related to the erroneous slice structure refers to the slice structure which is located in the video frame containing the erroneous slice structure, and is adjacent to the erroneous slice structure. When errors occur on a macro block in the slice structure, errors of the macro block may be concealed by using the macro block which is located in the slice structure prior to or next to the erroneous slice structure and located in the position identical to or adjacent to the position of the erroneous macro block in the slice structure.

The compressed video data transmitted over an OFDM channel breaks down into stream-oriented application and packet-oriented application. For stream-oriented applications, the receiving end must know the rule of the transmitting end allocating slice structures to OFDM sub-channels or sub-channels groups, so as to rearrange the slice structures on the received OFDM sub-channels or sub-channel groups and recover the original compressed video data. For packet-oriented application, the compressed video data is transmitted in the form of packets. Each slice structure includes several packets, and each packet has a serial number. The serial number of the packet is sent together with the packet data to the receiving end. Therefore, the receiving end does not need to know the rule of the transmitting end allocating slice structures to the OFDM sub-channels or sub-channel groups; and only needs to rearrange the slice structures according to the serial number of each packet in the slice structure, so as to obtain the original compressed video data. The method for concealing errors is described below in the scenarios that the compressed video data is oriented to streams and packets respectively.

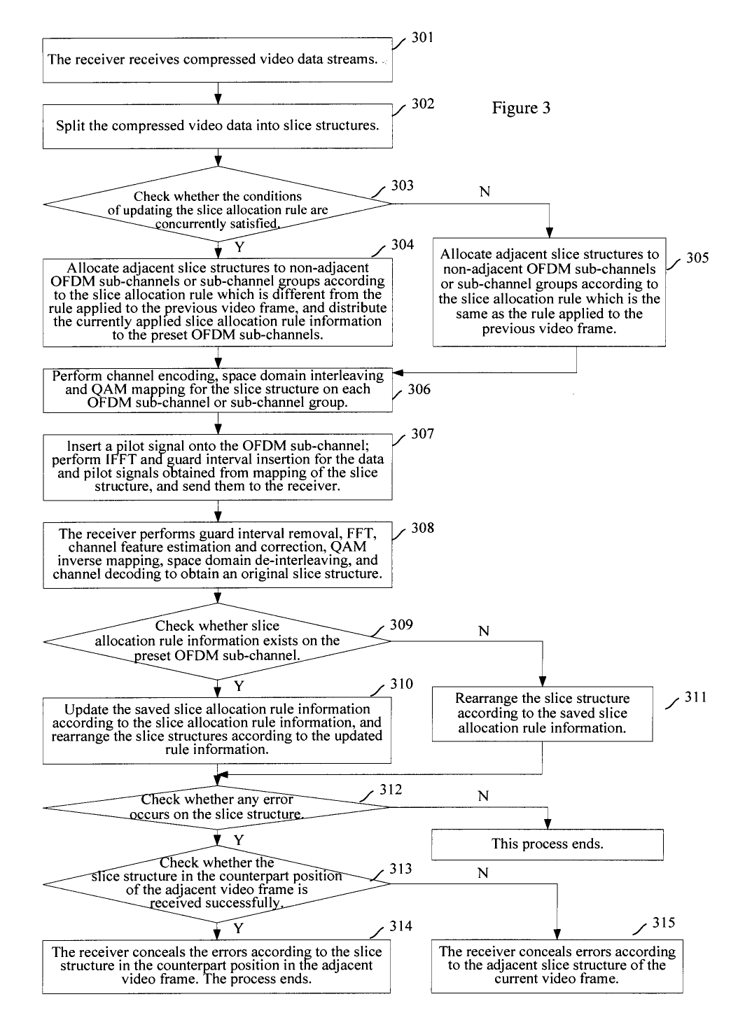

FIG. 3 shows the process of concealing errors during transmission of compressed video data on an OFDM channel according to the first embodiment of the present disclosure. The process includes the following steps:

Step 301: The transmitting end receives compressed video data streams.

Step 302: The transmitting end splits the received compressed video data into slice structures.

Step 303: The transmitting end determines whether the conditions of updating the slice allocation rule are currently satisfied. If the conditions are satisfied, the process proceeds to 304; otherwise, step 305 is performed.

Step 304: The transmitting end allocates adjacent slice structures to non-adjacent OFDM sub-channels or sub-channel groups according to the slice allocation rule which is preset and different from the rule applied to the previous video frame; and allocates the currently updated slice allocation rule information to the preset OFDM sub-channel. The process proceeds to step 306.

Each OFDM sub-channel or sub-channel group corresponds to a buffer. The slice structure is allocated to the buffer corresponding to the OFDM sub-channel or sub-channel group.

The slice allocation rule may be updated every fixed number of frames. After detecting that the number of currently received video frames is equal to the threshold for updating the preset slice allocation rule, the transmitting end updates the slice allocation rule. Alternatively, the transmitting end updates the slice allocation rule at intervals. For example, the transmitting end updates after detecting that the current time hits the preset update time. Alternatively, the transmitting end updates the slice allocation rule as indicated by the receiving end. Generally, when the receiving end performs channel feature estimation for the OFDM sub-channel, if detecting that the quality of the OFDM sub-channel is deteriorated (for example, lower than the preset channel quality), the receiving end sends an indication of updating slice allocation rules to the transmitting end. Alternatively, during channel decoding for the data on the OFDM sub-channel or sub-channel group, if detecting that data errors exist and the number of errors or non-correctable errors hits a preset threshold, the receiving end sends an indication of updating the slice allocation rule to the transmitting end. Alternatively, during decompression of the compressed video data composed of slice structures, if detecting that a slice structure is erroneous and the number of errors hits a preset threshold, the receiving end sends an indication of updating the slice allocation rule to the transmitting end.

The transmitting end and the receiving end negotiate the specific OFDM sub-channel to which the currently updated slice allocation rule information is distributed beforehand; or the network administrator pre-configures the rule information onto the transmitting end and the receiving end. Generally, the slice allocation rule information is allocated to idle OFDM sub-channels not occupied by the slice structure. For example, if the first idle OFDM sub-channel not occupied by the slice structure is preset for the purpose of storing the currently updated slice allocation rule information, supposing that there are 22 OFDM sub-channels numbered 0-21, of which sub-channels 0-19 are allocated to the slice structure, then sub-channels numbered 20 may be used to transmit the currently applied slice allocation rule information; and the sub-channel numbered 21 may be used to transmit other control information. If an OFDM sub-channel is occupied by a slice structure, the slice allocation rule information together with a slice structure is allocated to an OFDM sub-channel.

Step 305: Adjacent slice structures are allocated to non-adjacent OFDM sub-channels or sub-channel groups according to the slice allocation rule which is the same as the rule applied to the previous video frame.

Step 306: Channel encoding, space domain interleaving and QAM mapping consecutively are performed for the slice structure allocated to each OFDM sub-channel or sub-channel group.

Step 307: A pilot signal is inserted onto the OFDM sub-channel; IFFT and guard interval insertion are performed for the data obtained from mapping of QAM and the inserted pilot signal to obtain OFDM signals, and the OFDM signals are sent to the receiving end.

Step 308: After receiving the OFDM signal, the receiving end removes the guard interval, performs Fast Fourier Transform (FFT), performs channel correction and channel decoding according to the inserted pilot signal consecutively, and obtains the original slice structure on each OFDM sub-channel or sub-channel group.

Step 309: The receiving end determines whether updated slice allocation rule information exists on the preset OFDM sub-channel; if exists, the process proceeds to 310; otherwise, step 311 is performed.

Step 310: The receiving end uses the slice allocation rule information to update the currently saved slice allocation rule information, and arranges the OFDM sub-channels or the slice structures on the sub-channel according to the updated slice allocation rule information. The process proceeds to step 312.

Step 311: The receiving end arranges the OFDM sub-channels or the slice structures on the sub-channel according to the currently saved slice allocation rule information.

Step 312: The receiving end decompresses the compressed video data composed of slice structures, and determines whether any slice structure has errors. If any slice structure has errors, the process proceeds to step 313; otherwise, the process ends.

Step 313: The receiving end determines whether the slice structure in the counterpart position of the erroneous slice structure in the adjacent video frame is received successfully; if received successfully, the process proceeds to 314; otherwise, step 315 is performed.

Step 314: The receiving end conceals the errors of the erroneous slice structures according to the slice structure in the counterpart position in the adjacent video frame. The process is ended.

An adjacent video frame may be the frame prior to or next to the current video frame.

Step 315: The receiving end conceals the errors of the erroneous slice structures according to the slice structure which is successfully received by the current video frame and adjacent to the erroneous slice structure.

The adjacent slice structure may be the slice structure prior to or next to the current slice structure in the same video frame.

In this embodiment, if slice allocation rule information is allocated on the preset OFDM sub-channel, the slice allocation rule information may take no part in channel encoding, spatial domain interleaving, and QAM mapping, and undergo IFFT and guard interval insertion together with the slice structure on other OFDM sub-channels. Accordingly, the receiving end can obtain the original slice allocation rule information only by removing the guard interval and performing IFFT operation for the data on the preset OFDM sub-channel, without the need of channel feature estimation or correction, QAM inverse mapping, spatial domain de-interleaving, and channel decoding.

In the practical application, the transmitting end and the receiving end may pre-negotiate the applicable slice allocation rule before transmitting compressed video data, and the conditions of updating the allocation rule; alternatively, the network administrator may pre-configure the slice allocation rule and the conditions of updating the allocation rules onto the transmitting end and the receiving end.

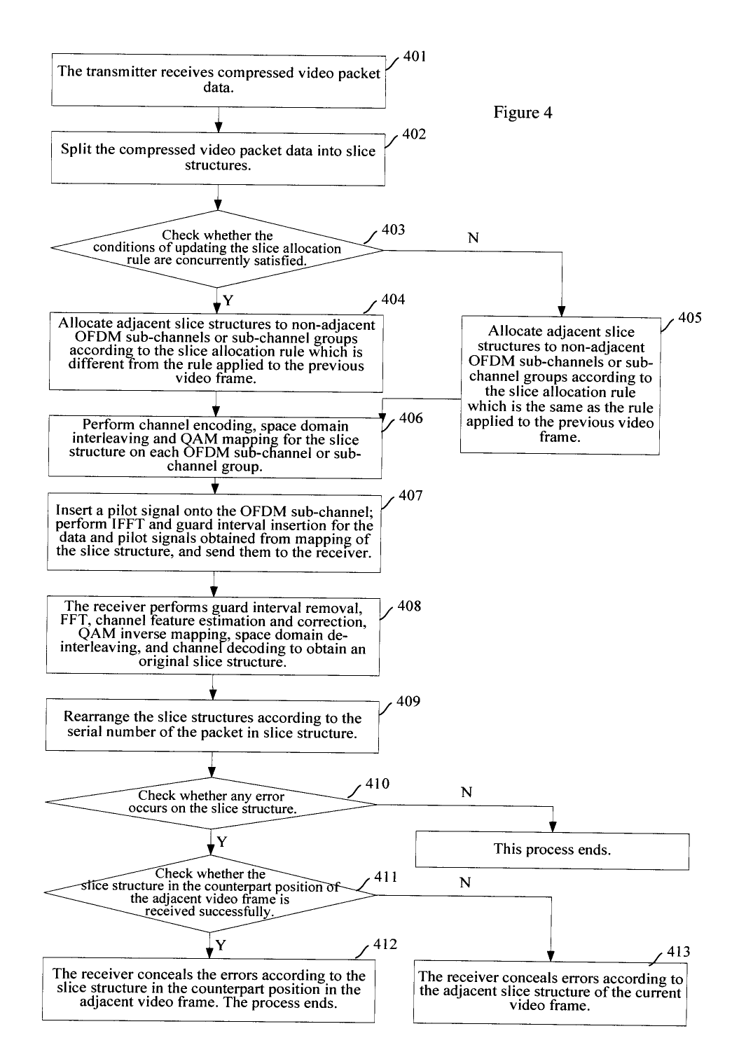

FIG. 4 shows the process of concealing errors when the compressed video data is oriented to packets according to the second embodiment of the present disclosure. The process includes the following steps:

Step 401: The transmitting end receives compressed video packet data.

Step 402: The transmitting end splits the received compressed video packet data into slice structures.

Step 403: The transmitting end determines whether the conditions of updating the slice allocation rule are currently satisfied. If the conditions are satisfied, the process proceeds to 404; otherwise, step 405 is performed.

Step 404: The transmitting end allocates adjacent slice structures to non-adjacent OFDM sub-channels or sub-channel groups according to the slice allocation rule which is preset and different from the rule applied to the previous video frame. The process proceeds to step 406.

Step 405: The transmitting end allocates adjacent slice structures to non-adjacent OFDM sub-channels or sub-channel groups according to the slice allocation rule which is the same as the rule applied to the previous video frame.

Step 406: The transmitting end performs channel encoding, space domain interleaving and QAM mapping consecutively for the slice structure allocated to each OFDM sub-channel or sub-channel group.

Step 407: The transmitting end inserts a pilot signal onto the OFDM sub-channel; performs IFFT and guard interval insertion for the data obtained from mapping of QAM and the inserted pilot signal to obtain OFDM signals, and sends the OFDM signals to the receiving end.

Step 408: After receiving the OFDM signal, the receiving end removes the guard interval, performs Fast Fourier Transform (FFT), performs channel correction and channel decoding according to the inserted pilot signal consecutively, and obtains the original slice structure on each OFDM channel.

Step 409: According to the serial number of the packet data in the slice structure, the receiving end arranges the slice structure.

Step 410: The receiving end decompresses the compressed video data of slice structures, and determines whether any slice structure has errors. If any slice structure has errors, the process proceeds to step 411; otherwise, the process ends.

Step 411: The receiving end determines whether the slice structure in the counterpart position of the erroneous slice structure in the adjacent video frame is received successfully; if received successfully, the process proceeds to 412; otherwise step 413 is performed.

Step 412: The receiving end conceals the errors of the erroneous slice structures according to the slice structure in the counterpart position in the adjacent video frame. The process is ended.

Step 413: The receiving end conceals the errors of the erroneous slice structures according to the slice structure which is successfully received by the current video frame and adjacent to the erroneous slice structure.

Given below is an instance of using the frequency domain interleaving method to conceal errors.

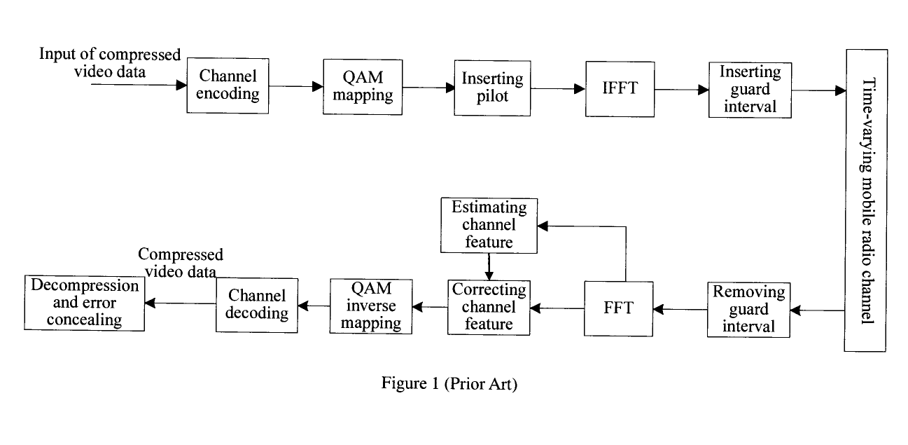

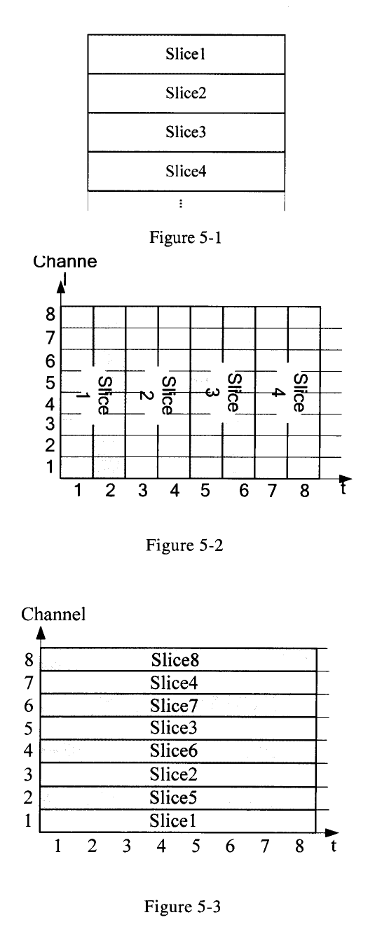

FIG. 5-1 is a schematic diagram of splitting a slice structure of compressed video data; FIG. 5-2 is a schematic diagram of allocating slice structures on each OFDM sub-channel when no frequency domain interleaving is performed for the compressed video data; FIG. 5-3 is a schematic diagram of allocating slice structures on each OFDM sub-channel when frequency domain interleaving is performed for the compressed video data. Suppose that the OFDM sub-channels 4 and 5 generate burst errors between time 2 and time 7, slices 1-4 may be affected by the errors concurrently when no frequency domain interleaving is performed for the compressed video data; because slices 1-4 are adjacent areas, the burst errors make it impossible to conceal errors effectively for the compressed video data in a large area, and impossible to recover correct compressed video data. After the frequency domain interleaving is performed for the compressed video data, one slice structure can be transmitted on only one OFDM sub-channel. Therefore, the errors of sub-channels 4 and 5 affect slice 3 and slice 6 only, and it is easy to use slice 2 and slice 4 to cover errors of slice 3, and use slice 5 and slice 7 to conceal errors of slice 6. As a result, the error data can be recovered effectively.

Given below is an instance of using the frequency domain interleaving method and time domain interleaving method to conceal errors.

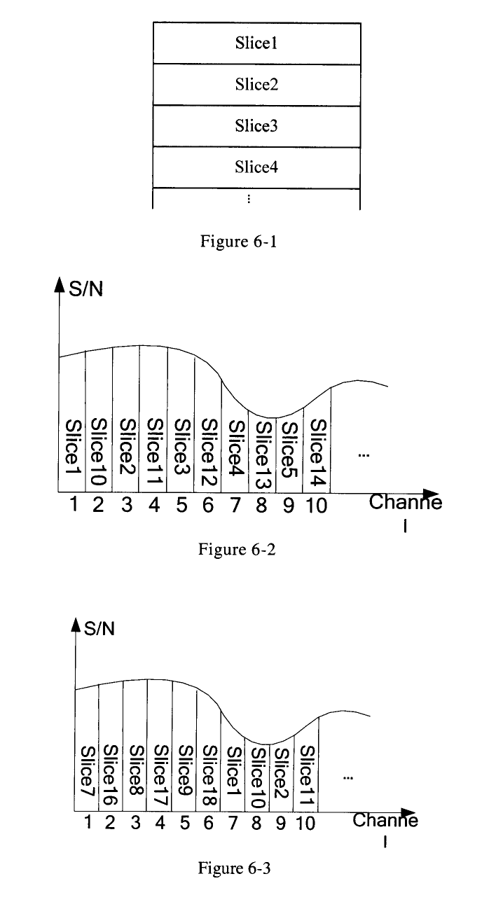

FIG. 6-1 is a schematic diagram of splitting a slice structure of compressed video data; FIG. 6-2 is a schematic diagram of allocating slice structures on each OFDM sub-channel when a frequency domain interleaving method is applied at time t0; FIG. 6-3 is a schematic diagram of allocating slice structures on each OFDM sub-channel when another frequency domain interleaving method is applied at time t1. Suppose that burst errors occur on OFDM sub-channels 7-9 at time t0, slices 4, 13 and 5 are affected by errors. At time t1, if the burst errors on OFDM sub-channels 7-9 still exist, slice 1, 10 and 2 are affected. As a result, after time domain interleaving is applied, the position of the slice structure affected by the burst errors is different at different times. The slice structure in the same position is unable to be received successfully because the slice structure in the same position always generates errors, and the recovery of the compressed video data is affected.

In the embodiment of the present disclosure, the frequency domain interleaving method only needs to ensure that the adjacent slice structures are allocated to non-adjacent OFDM sub-channels or sub-channel groups. Three frequency domain interleaving methods under the present disclosure are described below.

(i) Two-Time Odd-Even Interleaving Method:

Suppose that the serial number of the input slice structure is xᵢ; the serial number of the mapped OFDM sub-channel or sub-channel group is zᵢ; yᵢ is an intermediate variable, i=0, 1, . . . , N−1, where N is the total number of slice structures, then the following formulas apply:

It should be noted that, the └A┘ in the following formula means rounding-down of A if A is a rational number.

If N is an even number,

yᵢ=x_{└i/2┘*2+(1-i %2)}, i=0, 1, . . . , N−1 (1)

z₀=y₀ (2)

zᵢ=y_{1+└L(i-1)/2┘*2+(1-(i-1)%2)}, i=1, 2, . . . , N−2 (3)

z_{N-1}=y_{N-1} (4)

If N is an odd number,

yᵢ=x_{└i/2┘*2+(1-i %2)}, i=0, 1, . . . , N−2 (5)

y_{N-1}=x_{N-1} (6)

z₀=y₀ (7)

zᵢ=y_{1+└(i-1)/2┘*2+(1-(i-1)%2)}, i=1, 2, . . . , N−1 (8)

According to the foregoing formulas, the mapping relation between the serial number (xᵢ) of the slice structure and the serial number (zᵢ) of the OFDM sub-channel or sub-channel group when the total number of slice structures (N) is an even number “10” or odd number “9” is given below:

Table 1 shows the mapping relation between the serial number (xᵢ) of the slice structure and the serial number (zᵢ) of the OFDM sub-channel or sub-channel group when N=10 and the two-time odd-even interleaving method is applied:

TABLE 1
Mapping relation between the serial number (^{x}_{ⁱ}) of the slice
structure and the serial number (^{z}_{ⁱ}) of the OFDM
sub-channel or sub-channel group when N = 10 and the
two-time odd-even interleaving method is applied.

| xᵢ | yᵢ | zᵢ |
|---|---|---|
| 0 | 1 | 1 |
| 1 | 0 | 3 |
| 2 | 3 | 0 |
| 3 | 2 | 5 |
| 4 | 5 | 2 |
| 5 | 4 | 7 |
| 6 | 7 | 4 |
| 7 | 6 | 9 |
| 8 | 9 | 6 |
| 9 | 8 | 8 |

Table 2 shows mapping relation between the serial number (xᵢ) of the slice structure and the serial number (zᵢ) of the OFDM sub-channel or sub-channel group when N=9 and the two-time odd-even interleaving method is applied:

TABLE 2
Mapping relation between the serial number (^{x}_{ⁱ}) of the slice
structure and the serial number (^{z}_{ⁱ}) of the OFDM
sub-channel or sub-channel group when N = 9 and the
two-time odd-even interleaving method is applied

| xᵢ | yᵢ | zᵢ |
|---|---|---|
| 0 | 1 | 1 |
| 1 | 0 | 3 |
| 2 | 3 | 0 |
| 3 | 2 | 5 |
| 4 | 5 | 2 |
| 5 | 4 | 7 |
| 6 | 7 | 4 |
| 7 | 6 | 8 |
| 8 | 8 | 6 |

(ii) One-Second Interleaving Method a:

Suppose that the serial number of the input slice structure is xᵢ; the serial number of the mapped OFDM sub-channel or sub-channel group is zᵢ; S=└N/2┘, then the following formulas apply:

If N is an even number,

zᵢ=x_{└i/2┘+a}, i=0, 1, . . . , N−1 (9)

where, if i %2=0, a=0; if i %2=1, a=S.

If N is an odd number,

z₀=x_{N-1} (10)

zᵢ=x_{└(i-1)/2┘+b}, i=1, 2, . . . , N−1 (11)

where, if (i−1)%2=0, b=0; if (i−1)%2=1, b=S.

According to the foregoing formulas, the mapping relation between the serial number (xᵢ) of the slice structure and the serial number (zᵢ) of the OFDM sub-channel or sub-channel group when the total number of slice structures (N) is an even number “10” or odd number “9” is given below:

Table 3 shows the mapping relation between the serial number (xᵢ) of the slice structure and the serial number (zᵢ) of the OFDM sub-channel or sub-channel group when N=10 and the one-second interleaving method A is applied:

TABLE 3
Mapping relation between the serial number (^{x}_{ⁱ}) of the slice
structure and the serial number (^{z}_{ⁱ}) of the OFDM
sub-channel or sub-channel group when N = 10 and
the one-second interleaving method A is applied

| xᵢ | zᵢ |
|---|---|
| 0 | 0 |
| 1 | 5 |
| 2 | 1 |
| 3 | 6 |
| 4 | 2 |
| 5 | 7 |
| 6 | 3 |
| 7 | 8 |
| 8 | 4 |
| 9 | 9 |

Table 4 shows the mapping relation between the serial number (xᵢ) of the slice structure and the serial number (zᵢ) of the OFDM sub-channel or sub-channel group when N=9 and the one-second interleaving method A is applied:

TABLE 4
Mapping relation between the serial number (^{x}_{ⁱ}) of the slice
structure and the serial number (^{z}_{ⁱ}) of the OFDM
sub-channel or sub-channel group when N = 9 and
the one-second interleaving method A is applied.

| xᵢ | zᵢ |
|---|---|
| 0 | 8 |
| 1 | 0 |
| 2 | 4 |
| 3 | 1 |
| 4 | 5 |
| 5 | 2 |
| 6 | 6 |
| 7 | 3 |
| 8 | 7 |

(iii) One-Second Interleaving Method B:

Suppose that the serial number of the input slice structure is Xᵢ; the serial number of the mapped OFDM sub-channel or sub-channel group is zᵢ; S=N/2, then the following formulas apply:

If N is an even number,

zᵢ=x_{└i/2┘+a}, i=0, 1, . . . , N−1 (12)

where, if i %2=0, a=0; if i %2=1, a=S.

If N is an odd number,

z₀=x_{N-1} (13)

zᵢ=x_{└(i-1)/2┘+b}, i=1, 2, . . . , N−1 (14)

where, if (i−1)%2=0, b=0; if (i−1)%2=1, b=S.

According to the foregoing formulas, the mapping relation between the serial number (xᵢ) of the slice structure and the serial number (zᵢ) of the OFDM sub-channel or sub-channel group when the total number of slice structures (N) is an even number “10” or odd number “9” is given below:

Table 5 shows the mapping relation between the serial number (xᵢ) of the slice structure and the serial number (zᵢ) of the OFDM sub-channel or sub-channel group when N=10 and the one-second interleaving method B is applied:

TABLE 5
Mapping relation between the serial number (^{x}_{ⁱ}) of the slice
structure and the serial number (^{z}_{ⁱ}) of the OFDM
sub-channel or sub-channel group when N = 9 and
the one-second interleaving method B is applied

| xᵢ | zᵢ |
|---|---|
| 0 | 5 |
| 1 | 0 |
| 2 | 6 |
| 3 | 1 |
| 4 | 7 |
| 5 | 2 |
| 6 | 8 |
| 7 | 3 |
| 8 | 9 |
| 9 | 4 |

Table 6 shows the mapping relation between the serial number (xᵢ) of the slice structure and the serial number (zᵢ) of the OFDM sub-channel or sub-channel group when N=9 and the one-second interleaving method B is applied:

TABLE 6
Mapping relation between the serial number (^{x}_{ⁱ}) of the slice
structure and the serial number (^{z}_{ⁱ}) of the OFDM
sub-channel or sub-channel group when N = 9 and
the one-second interleaving method B is applied

| xᵢ | zᵢ |
|---|---|
| 0 | 8 |
| 1 | 4 |
| 2 | 0 |
| 3 | 5 |
| 4 | 1 |
| 5 | 6 |
| 6 | 2 |
| 7 | 7 |
| 8 | 3 |

The time domain interleaving method in an embodiment of the present disclosure may map the slice structures in the counterpart position of adjacent video frames to different OFDM sub-channels or sub-channel groups, so that the errors can be concealed by using the slice structure in the counterpart position of the adjacent video frame when errors occur on the slice structure due to long fading of some OFDM sub-channels or sub-channel groups. Two time-domain interleaving methods in an embodiment of the present disclosure are given below:

(i) Interleaving Handover Method:

The interleaving handover method is: the same frequency domain interleaving method is applied repeatedly at preset intervals or every preset number of video frames, measured in time intervals or video frames; and different frequency domain interleaving methods are applied at adjacent preset intervals or every preset number of adjacent video frames.

For example, suppose that the serial number of the video frame is M; if M is an even number, the frequency domain interleaving method is a two-time odd-even interleaving method; if M is an odd number, the frequency interleaving method is one-second interleaving method A.

For odd-number video frames and even-number video frames, different mapping relations are given below between the serial number (xᵢ) of the slice structure and the serial number (zᵢ) of the OFDM sub-channel or sub-channel group when the total number of slice structures (N) is 10 or 9:

TABLE 7
For odd-number video frames and even-number video frames,
different mapping relations between the serial number
(^{x}_{ⁱ}) of the slice structure and the serial number (^{z}_{ⁱ})
of the OFDM sub-channel or sub-channel group when the
total number of slice structures (N) is 10 and interleaving
handover is applied.

| | Serial number | Serial number |
|---|---|---|
| | of OFDM sub-channel | of OFDM sub-channel |
| | or sub-channel | or sub-channel |
| Serial number | group corresponding | group corresponding |
| of slice | to even-number | to odd-number |
| structure (^{x}_{ⁱ}) | video frame (^{z}_{ⁱ}) | video frame (^{z}_{ⁱ}) |
| 0 | 1 | 0 |
| 1 | 3 | 5 |
| 2 | 0 | 1 |
| 3 | 5 | 6 |
| 4 | 2 | 2 |
| 5 | 7 | 7 |
| 6 | 4 | 3 |
| 7 | 9 | 8 |
| 8 | 6 | 4 |
| 9 | 8 | 9 |

TABLE 8
For odd-number video frames and even-number video frames,
different mapping relations between the serial number
(^{x}_{ⁱ}) of the slice structure and the serial number (^{z}_{ⁱ})
of the OFDM sub-channel or sub-channel group when the
total number of slice structures (N) is 9 and interleaving
handover is applied.

| | Serial number | Serial number |
|---|---|---|
| | of OFDM sub-channel | of OFDM sub-channel |
| | or sub-channel | or sub-channel |
| Serial number | group corresponding | group corresponding |
| of slice | to even-number | to odd-number |
| structure (^{x}_{ⁱ}) | video frame (^{z}_{ⁱ}) | video frame (^{z}_{ⁱ}) |
| 0 | 1 | 8 |
| 1 | 3 | 0 |
| 2 | 0 | 4 |
| 3 | 5 | 1 |
| 4 | 2 | 5 |
| 5 | 7 | 2 |
| 6 | 4 | 6 |
| 7 | 8 | 3 |
| 8 | 6 | 7 |

(ii) Interleaving Tandem Handover:

The principles of the interleaving tandem handover method are: the same frequency domain interleaving method is applied repeatedly at preset intervals or every preset number of video frames; and different frequency domain interleaving methods are applied at adjacent preset intervals or every preset number of adjacent video frames; the same or different frequency domain interleaving operation is performed twice in at least one preset time interval or preset number of video frames.

For example, suppose that the serial number of the video frame is M, when M is an even number, the frequency domain interleaving method is one-second interleaving method A; when M is an odd number, the one-second interleaving method A is applied first, and the one-second interleaving method B is applied to the obtained result. For odd-number video frames and even-number video frames, different mapping relations are listed below between the serial number (xᵢ) of the slice structure and the serial number (zᵢ) of the OFDM sub-channel or sub-channel group when the total number of slice structures (N) is 10 or 9:

TABLE 9
For odd-number video frames and even-number video frames,
different mapping relations between the serial number
(^{x}_{ⁱ}) of the slice structure and the serial number (^{z}_{ⁱ})
of the OFDM sub-channel or sub-channel group when the
total number of slice structures (N) is 10 and interleaving
tandem handover is applied.

| | Serial number | Serial number |
|---|---|---|
| | of OFDM sub-channel | of OFDM sub-channel |
| | or sub-channel | or sub-channel |
| Serial number | group corresponding | group corresponding |
| of slice | to even-number | to odd-number |
| structure (^{x}_{ⁱ}) | video frame (^{z}_{ⁱ}) | video frame (^{z}_{ⁱ}) |
| 0 | 1 | 3 |
| 1 | 3 | 5 |
| 2 | 0 | 1 |
| 3 | 5 | 7 |
| 4 | 2 | 0 |
| 5 | 7 | 9 |
| 6 | 4 | 2 |
| 7 | 9 | 8 |
| 8 | 6 | 4 |
| 9 | 8 | 6 |

TABLE 10
For odd-number video frames and even-number video frames,
different mapping relations between the serial number
(^{x}_{ⁱ}) of the slice structure and the serial number (^{z}_{ⁱ})
of the OFDM sub-channel or sub-channel group when the
total number of slice structures (N) is 9 and interleaving
tandem handover is applied.

| | Serial number | Serial number |
|---|---|---|
| | of buffer | of buffer |
| | corresponding | corresponding |
| Serial number | to even-number | to odd-number |
| of slice (^{x}_{ⁱ}) | video frame (^{z}_{ⁱ}) | video frame (^{z}_{ⁱ}) |
| 0 | 1 | 3 |
| 1 | 3 | 5 |
| 2 | 0 | 1 |
| 3 | 5 | 7 |
| 4 | 2 | 0 |
| 5 | 7 | 8 |
| 6 | 4 | 2 |
| 7 | 8 | 6 |
| 8 | 6 | 4 |

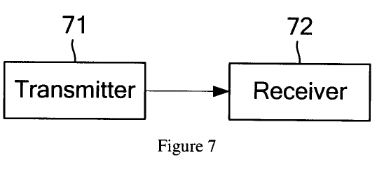

FIG. 7 shows the composition of a system for concealing errors during transmission of compressed video data on an OFDM channel in an embodiment of the present disclosure. The system includes:

a transmitting end 71, configured to, after receiving compressed video data input externally, split the compressed video data into slice structures, allocate adjacent slice structures to non-adjacent OFDM sub-channels or sub-channel groups, and send the slice structures to a receiving end 72; and

the receiving end 72, configured to read the slice structures on the OFDM sub-channel or sub-channel group from the transmitting end 71, and, if an error is detected on a slice structure, conceal the error of the slice structure according to the successfully received slice structure which is chronologically or spatially related to the erroneous slice structure.

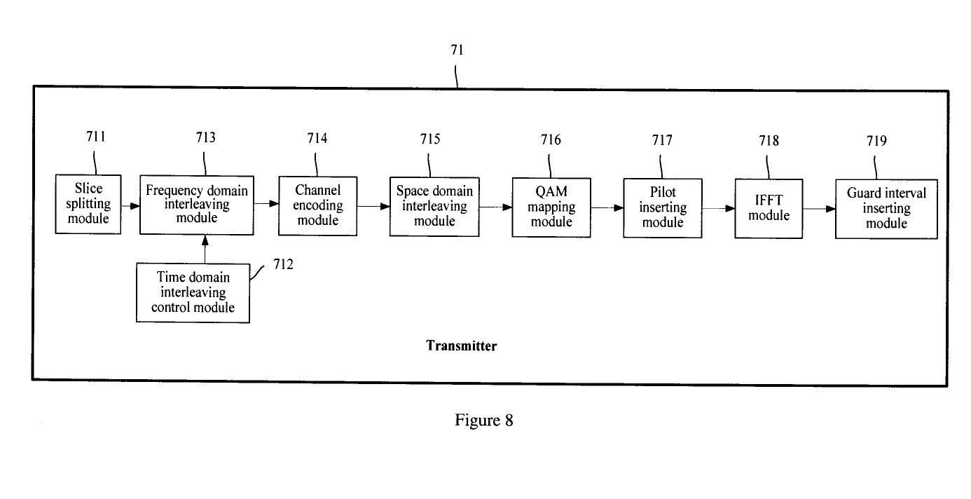

FIG. 8 shows the structure of a transmitting end provided in an embodiment of the present disclosure. As shown in FIG. 8, a transmitting end 71 includes:

a slice splitting module 711, configured to split compressed video data input externally into slice structures and send the slice structures to the frequency domain interleaving module 713;

a time domain interleaving control module 712, configured to save the conditions of updating the slice allocation rules, and, when detecting that the update conditions are satisfied, send an update indication to the frequency domain interleaving module 713;

a frequency domain interleaving module 713, configured to save the slice allocation rule information, and, when receiving a slice structure from the slice splitting module 711 and receiving no update indication from the time domain interleaving control module 712, use the slice allocation rule identical to the rule applied to previous video frame to allocate the adjacent slice structures of the received current video frame to non-adjacent OFDM sub-channels or sub-channel groups, send the slice structures to the channel encoding module 714, and, when receiving a slice structure from the slice splitting module 711 and receiving an update indication from the time domain interleaving control module 712, use the slice allocation rule which is different from the rule applied to the previous video frame to allocate the adjacent slice structure of the received current video frame to the non-adjacent OFDM sub-channels or sub-channel group, and send the slice structures to the channel encoding module 714;

a channel encoding module 714, configured to encode the data on the OFDM sub-channels or sub-channel group from the frequency domain interleaving module 713 and send the encoded data to the space domain interleaving module 715;

a space domain interleaving module 715, configured to perform space domain interleaving for the data on the OFDM sub-channels or sub-channel group from the channel encoding module 714, and send the obtained data to the QAM mapping module 716;

a QAM mapping module 716, configured to perform QAM mapping for the data on each OFDM sub-channel or sub-channel group from the space domain interleaving module 715, and send the encoded data to the pilot inserting module 717;

a pilot inserting module 717, configured to receive the data on each OFDM sub-channel or sub-channel group from the QAM mapping module 716, insert the pilot data into the OFDM sub-channel, and send the data on each OFDM sub-channel or sub-channel group to the IFFT module 718;

an IFFT module 718, configured to perform IFFT for the data on each OFDM sub-channel or sub-channel group from the pilot inserting module 717 and send the obtained data to the guard interval inserting module 719; and

a guard interval inserting module 719, configured to insert a guard interval to the data on each OFDM sub-channel or sub-channel group from the IFFT module 718 and send the obtained data to the receiving end.

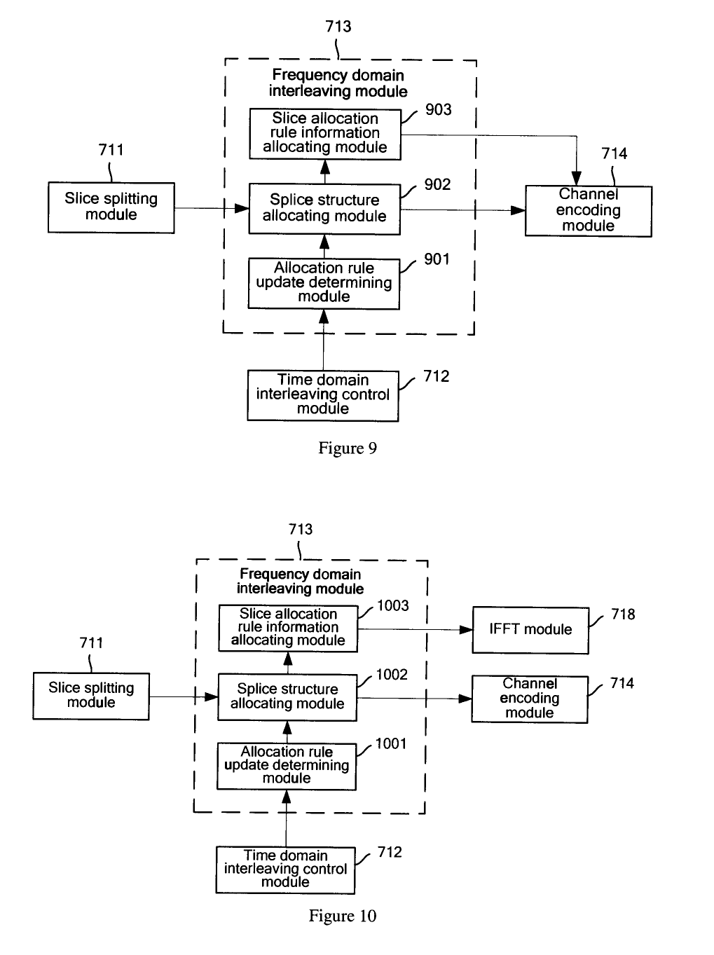

FIG. 9 is the first schematic diagram for the structure of a frequency domain interleaving module provided in an embodiment of the present disclosure. A frequency domain interleaving module includes:

an allocation rule update determining module 901, configured to send an allocation rule update indication to the slice structure allocation module 902 after receiving an update indication from the time domain interleaving control module 712;

a slice structure allocation module 902, configured to save the slice allocation rule information, and, when receiving a slice structure from the slice splitting module 711 and receiving no allocation rule update indication from the allocation rule update determining module 901, use the slice allocation rule identical to the rule applied to previous video frame to allocate the adjacent slice structures of the received current video frame to the non-adjacent OFDM sub-channels or sub-channel group, send the slice structures to the channel encoding module 714, and, when receiving a slice structure from the slice splitting module 711 and receiving an allocation rule update indication from the allocation rule update determining module 901, use the slice allocation rule which is different from the rule applied to the previous video frame to allocate the adjacent slice structure of the received current video frame to the non-adjacent OFDM sub-channels or sub-channel group, send the slice structures to the channel encoding module 714, and send the currently applied slice allocation rule information to the slice allocation rule information allocating module 903; and

an slice allocation rule information allocating module 903, configured to allocate the slice allocation rule information from the slice structure allocating module 902 to the OFDM sub-channel, and send the data on the OFDM sub-channel to the channel encoding module 714.

FIG. 10 is the second schematic diagram for the structure of a frequency domain interleaving module provided in an embodiment of the present disclosure. A frequency domain interleaving module includes: an allocation rule update determining module 1001, a slice structure allocating module 1002, and a slice allocation rule information allocating module 1003.

The allocation rule update determining module 1001 is the same as the allocation rule update determining module 901; the slice structure allocating module 1002 is the same as the slice structure allocating module 902; the slice allocation rule information allocating module 1003 is different from the slice allocation rule information allocating module 903 in that: the slice allocation rule information allocating module 1003 allocates the slice allocation rule information from the slice structure allocating module 1002 to the OFDM sub-channel, and then sends the data on the OFDM sub-channel to the IFFT module 718.

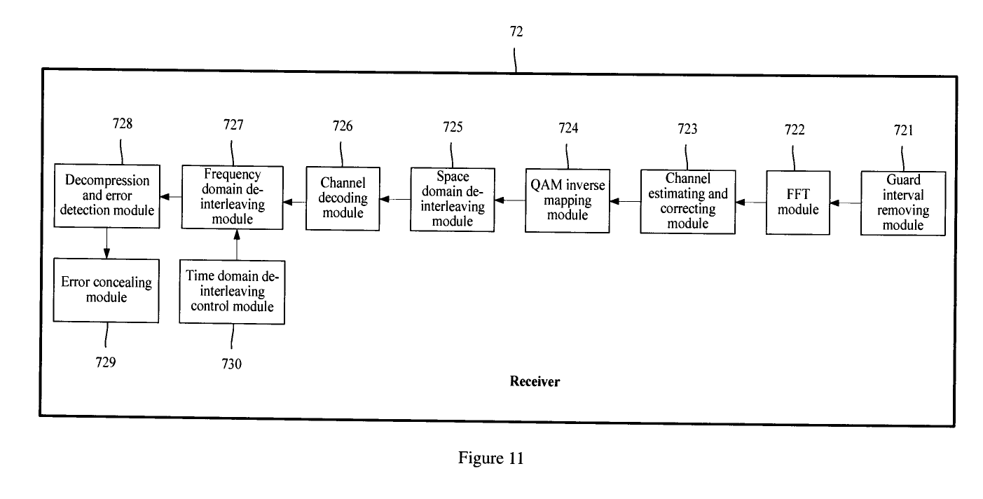

FIG. 11 shows the structure of a receiving end provided in an embodiment of the present disclosure. As shown in FIG. 11, a receiving end 72 includes:

a guard interval removing module 721, configured to remove the guard interval on the data on each OFDM sub-channel or sub-channel group sent from the transmitting end 71 and send the obtained data to the FFT module 722;

an FFT module 722, configured to perform FFT for the data on each OFDM sub-channel or sub-channel group from the guard interval removing module 721 and send the obtained data to the channel estimating and correcting module 723;

a channel estimating and correcting module 723, configured to estimate the channel features according to the pilot data on the OFDM sub-channel sent from the FFT module, correct the compressed video data on the OFDM sub-channel or sub-channel group according to the estimation result, and send the obtained data to the QAM inverse mapping module 724;

a QAM inverse mapping module 724, configured to perform QAM inverse mapping for the data on each OFDM sub-channel or sub-channel group from the channel estimating and correcting module 723 and send the obtained data to the space domain de-interleaving module 725;

a space domain de-interleaving module 725, configured to perform space domain de-interleaving for the data on the OFDM sub-channels or sub-channel group from the QAM inverse mapping module 724 and send the obtained data to the channel decoding module 726;

a channel decoding module 726, configured to decode the data on each OFDM sub-channel or sub-channel group from the space domain de-interleaving module 725 and output the encoded data to the frequency domain de-interleaving module 727;

a frequency domain de-interleaving module 727, configured to read the slice structures on each OFDM sub-channel or sub-channel group from the channel decoding module 726, arrange the slice structures, and send the arranged slice structures to the decompression & error detection module 728;

a decompression and error detection module 728, configured to decompress the compressed video data composed of slice structures from the frequency domain de-interleaving module 727, and, when detecting that any error occurs on a slice structure, send the information related to the slice structure (for example, frame identifier of the video frame that contains the slice structure, the location of the slice structure in the video frame) to the error concealing module 729; and

an error concealing module 729, configured to receive the slice structure information sent by the decompression and error detection module 728, and, according to the information on the erroneous slice structure, conceal the errors of the erroneous slice structure by using the slice structure which is successfully received by the video frame adjacent to the video frame containing the erroneous slice structure and is adjacent to the erroneous slice structure.

Further, the receiving end 72 includes a time domain de-interleaving control module 730, configured to send the slice allocation rule information (which is configured on the time domain interleaving control module, or is sent from the channel decoding module 726 or FFT module 722 and is updated on a preset OFDM sub-channel) to the frequency domain de-interleaving module 727, whereupon the frequency domain de-interleaving module 727 arranges the slice structures according to the slice allocation rule information.

After study of the above embodiments, those skilled in the art understand that the disclosure may be realized through software and general hardware platforms or through hardware only. In most cases, it is preferred to use software plus general hardware platforms. Based on such understanding, the technical solution provided in embodiments of the disclosure or contributions to the prior art can be embodied in software products. The software is stored in a storage medium and incorporates several instructions to instruct a computer device, for example, a PC, a server, or a network device, to execute the method provided in the embodiments of the present disclosure. It should be appreciated that the foregoing is only preferred embodiments of the disclosure and is not used to limit the disclosure. Any modification, equivalent substitution, and improvement without departing from the spirit and principle of this disclosure shall be covered in the protection scope of the disclosure.

Although the disclosure has been described through some exemplary embodiments, the disclosure is not limited to such embodiments. It is apparent that those skilled in the art can make various modifications and variations to the disclosure without departing from the scope of the disclosure. The disclosure shall cover the modifications and variations provided that they fall in the scope of protection defined by the following claims or their equivalents.

What is claimed is:

1. A method for concealing an error comprising:
receiving, by a receiving end, a plurality of slice structures from an Orthogonal Frequency Division Multiplexing (OFDM) sub-channel or sub-channel group;
allocating adjacent slice structures to non-adjacent OFDM sub-channels or sub-channel groups;
detecting an error slice structure; and
concealing the error slice structure according to one or more of the slice structures which are chronologically or spatially related to the error slice if the error slice was detected.

2. The method of claim 1, further comprising:
sending, if detecting that data errors exist and the number of errors or non-correctable errors hits a preset threshold, an indication of updating a slice allocation rule from the receiving end to a transmitting end, and determining by the transmitting end, after receiving the indication, whether the conditions of updating the slice allocation rule are satisfied; or
sending, if detecting that a slice structure is erroneous and the number of errors hits a preset threshold during decompression of compressed video data composed of slice structures, an indication of updating a slice allocation rule by the receiving end to a transmitting end, and determining by the transmitting end, after receiving the indication, whether the conditions of updating the slice allocation rule are satisfied.

3. The method of claim 1, further comprising:
receiving a slice allocation rule of allocating adjacent slice structures to non-adjacent OFDM sub-channels or sub-channel groups; and
arranging, according to the slice allocation rule, the slice structure for reading.

4. The method of claim 1, further comprising:
reading, after receiving the slice structures from the OFDM sub-channels or sub-channel groups and before detecting an error, a serial number of packet data in the slice structures; and
arranging the slice structure for reading.

5. The method of claim 4, further comprising:
removing a guard interval;
performing a Fast Fourier Transform; and
performing a channel correction and channel decoding according to an inserted pilot signal.

6. The method of claim 1, wherein the slice structure which is chronologically or spatially related to the erroneous slice structure comprising a slice structure located:
(a) in a reference video frame of a video frame containing the erroneous slice structure and related to the position of the erroneous slice structure, or (b) in the video frame containing the erroneous slice structure, and adjacent to the erroneous slice structure.

7. A method for concealing an error comprising:
receiving, by a transmitting end, compressed video data;
splitting the compressed video data into slice structures;
determining whether a condition of updating a slice allocation rule is satisfied;
allocating, if the condition is satisfied, adjacent slice structures to non-adjacent Orthogonal Frequency Division Multiplexing (OFDM) sub-channels or sub-channel groups according to a slice allocation rule, wherein the slice allocation rule is preset and different from a rule applied to a previous video frame; and
allocating, if the condition is not satisfied, adjacent slice structures to non-adjacent OFDM sub-channels or sub-channel groups according to a slice allocation rule, wherein the slice allocation rule is the same as the rule applied to a previous video frame.

8. The method of claim 7, wherein the determining whether the condition of updating the slice allocation rule is satisfied comprises:
detecting whether a current time is equal to a preset update time; or
detecting whether a number of currently received video frames is equal to a threshold for updating the preset slice allocation rule; or
detecting whether an indication is obtained by a receiving end.

9. The method of claim 8, further comprising:
sending by the receiving end, when the receiving end detects the quality of the OFDM sub-channel is lower than the preset channel quality before the determining whether the condition of updating the slice allocation rule is satisfied, an indication of updating slice allocation rules to the transmitting end.

10. The method of claim 7, further comprising:
sending, by the transmitting end, slice allocation rule information to the receiving end; or
pre-configuring slice allocation rule information onto the transmitting end; or
allocating slice allocation rule information to an OFDM sub-channel, and sending the slice allocation rule information by the OFDM sub-channel to the transmitting end.

11. The method of claim 10, wherein the allocating the slice allocation rule information to an OFDM sub-channel, and sending the slice allocation rule information by the OFDM sub-channel to the transmitting end comprises:
performing at least one of channel encoding, spatial domain interleaving, Quadrature Amplitude Modulation (QAM) mapping, and undergoing Inverse Fast Fourier Transform (IFFT) and guard interval insertion together with allocating the slice structure on other OFDM sub-channels, and sending the slice allocation rule to the transmitting end, or
generating the slice allocation rule information and the slice allocation together with a pilot signal undergoing IFFT and guard interval insertion, and sending the slice allocation rule to the transmitting end.

12. The method of claim 7, further comprising:
performing at least one of channel encoding, space domain interleaving, Quadrature Amplitude Modulation (QAM) mapping, inserting a pilot signal, performing Inverse Fast Fourier Transform (IFFT) and guard interval insertion for the slice structure allocated to each OFDM sub-channel or sub-channel group after allocating the adjacent slice structures to the non-adjacent OFDM sub-channels or sub-channel groups.

13. A system for concealing errors comprising:
a transmitting end adapted to, after receiving compressed video data input, split the compressed video data into slice structures, allocate adjacent slice structures to the non-adjacent Orthogonal Frequency Division Multiplexing (OFDM) sub-channels or sub-channel groups, and send the slice structures to a receiving end; and
the receiving end adapted to read the slice structures on the OFDM sub-channels or sub-channel groups from the transmitting end, and conceal, if an error is detected on a slice structure, the error according to the slice structure which is chronologically or spatially related to the erroneous slice structure.

14. The system of claim 13, the transmitting end comprising:
a slice splitting module adapted to split compressed video data input into slice structures and send the slice structures to a frequency domain interleaving module; and
the frequency domain interleaving module adapted to allocate the adjacent slice structures to the non-adjacent OFDM sub-channels or sub-channel groups, and send the slice structure to the receiving end.

15. The system of claim 13, the receiving end, comprising:
a frequency domain de-interleaving module adapted to read the slice structures on the OFDM sub-channels or sub-channel groups from the transmitting end, arrange the slice structures, and send the arranged slice structures to a decompression and error detection module;
the decompression and error detection module adapted to decompress the received slice structures, and send, if an error is detected on the slice structures, the slice structure information to an error concealing module; and
the error concealing module adapted to, after receiving the slice structure information from the decompression and error detection module, conceal the error according to the slice structure which is chronologically or spatially related to the erroneous slice structure.

16. A transmitting end comprising:
a slice splitting module adapted to split compressed video data input into slice structures and send the slice structures to a frequency domain interleaving module; and
the frequency domain interleaving module adapted to allocate the received adjacent slice structures of the current video frame to non-adjacent Orthogonal Frequency Division Multiplexing (OFDM) sub-channels or sub-channel groups and send the slice structures to a receiving end.

17. The transmitting end of claim 16, further comprising:
a time domain interleaving control module adapted to save conditions for updating slice allocation rules, and send, when detecting that the conditions are satisfied, an update indication to the frequency domain interleaving module, and
the frequency domain interleaving module further comprises:
an allocation rule update determining module adapted to send an allocation rule update indication to a slice structure allocation module after receiving an update indication from the time domain interleaving control module; and
a slice structure allocation module adapted to receive the slice structure of the compressed video packet data, wherein:
if the slice structure allocation module receives no indication of updating the preset slice allocation rule, the slice structure allocation module is further adapted to use a slice allocation rule identical to a rule applied to a previous video frame to allocate adjacent slice structures of the received current video frame to non-adjacent OFDM sub-channels or sub-channel groups, and send the slice structures to the receiving end;
if the slice structure allocation module receives an indication of updating the preset slice allocation rule, the slice structure allocation module is further adapted to uses a slice allocation rule which is different from a rule applied to a previous video frame to allocate adjacent slice structures of the received current video frame to non-adjacent OFDM sub-channels or sub-channel groups, and send the slice structures to the receiving end.

18. The transmitting end of claim 16, further comprising:
a channel encoding module;
a space domain interleaving module;
a Quadrature Amplitude Modulation (QAM) mapping module;
a pilot inserting module;
an Inverse Fast Fourier Transform (IFFT) module; and
a guard interval inserting module, wherein
the channel encoding module is adapted to encode data on the OFDM sub-channels or sub-channel groups from the frequency domain interleaving module and send the encoded data to the space domain interleaving module,
the space domain interleaving module is adapted to perform space domain interleaving for the data on the OFDM sub-channels or sub-channel groups from the channel encoding module, and send the obtained data to the QAM mapping module,
the QAM mapping module is adapted to perform QAM mapping for the data on the OFDM sub-channels or sub-channel group received from the space domain interleaving module, and send the encoded data to the pilot inserting module,
the pilot inserting module is adapted to receive the data on the OFDM sub-channels or sub-channel group from the QAM mapping module, insert pilot data into the OFDM sub-channels, and send the data on the OFDM sub-channels or sub-channel group to the IFFT module,
the IFFT module is adapted to perform IFFT for the data on the OFDM sub-channels or sub-channel group received from the pilot inserting module, and send the obtained data to the guard interval inserting module, and
the guard interval inserting module is adapted to insert a guard interval to the data on the OFDM sub-channels or sub-channel group from the IFFT module, and send the obtained data to the receiving end.

19. A receiving end, comprising:
a frequency domain de-interleaving module;
a decompression and error detection module; and
an error concealing module, wherein
the frequency domain de-interleaving module is adapted to read slice structures on Orthogonal Frequency Division Multiplexing (OFDM) sub-channels or sub-channel group from a transmitting end, arrange the slice structures, and send the arranged slice structures to the decompression and error detection module,
the decompression and error detection module is adapted to decompress the received slice structures, and send, if an error is detected on the slice structures, the slice structure information to the error concealing module, and
the error concealing module is adapted to conceal, after receiving the slice structure information from the decompression and error detection module, the error according to the slice structure which is chronologically or spatially related to the erroneous slice structure.

20. The receiving end of claim 19, further comprising:
a guard interval removing module;
a Fast Fourier Transform (FFT) module;
a channel estimating and correcting module;
a Quadrature Amplitude Modulation (QAM) inverse mapping module;
a space domain de-interleaving module; and
a channel decoding module, wherein
the guard interval removing module is adapted to remove a guard interval on data on each OFDM sub-channel or sub-channel group sent from a transmitting end and send data obtained when removing the guard interval to the FFT module,
the FFT module is adapted to perform FFT for the data on each OFDM sub-channel or sub-channel group, and send data obtained when performing the FFT to the channel estimating and correcting module,
the channel estimating and correcting module is adapted to estimate the channel features according to pilot data on the OFDM sub-channel, correct the compressed video data on the OFDM sub-channel or sub-channel group according to the estimation result, and send data obtained when estimating the channel features to the QAM inverse mapping module,
the QAM inverse mapping module is adapted to perform QAM inverse mapping for the data on each OFDM sub-channel or sub-channel group from the channel estimating and correcting module, and send data obtained when performing the QAM inverse mapping to the space domain de-interleaving module,
the space domain de-interleaving module is adapted to perform space domain de-interleaving for the data on the OFDM sub-channels or sub-channel group, and send data obtained when performing the space domain de-interleaving to the channel decoding module, and
the channel decoding module is adapted to decode the data on each OFDM sub-channel or sub-channel group, and output the decoded data to the frequency domain de-interleaving module.

21. The receiving end of claim 19, further comprising:
a time domain de-interleaving control module adapted to send slice allocation rule information which is (a) configured on the time domain interleaving control module, or (b) sent from the channel decoding module or the FFT module, and is updated on a preset OFDM sub-channel to the frequency domain de-interleaving module.
